(19) United States
(12) Patent Application Publication
(10) Pub. No.: US 2006/0157437 A1
(43) Pub. Date: Jul. 20, 2006

(54) Container with a dispenser

(76) Inventor: Smadar Tamir, Givataim (IL)

Correspondence Address: DANIEL J SWIRSKY, 55 REUVEN ST., BEIT SHEMESH, 99544, IL

(21) Appl. No.: 11/036,061

(22) Filed: Jan. 18, 2005

(51) Int. Cl. A61J 9/00

(52) U.S. Cl. 215/11.3

(57) ABSTRACT

The present invention discloses a cost effective container integrally attached to at least one flexible dispenser, comprising a ready to use flowing edible content. The present invention also discloses novel method of providing ready to use edible foodstuffs or beverages to users such as babies and toddlers that cannot use bottles having an aperture with a plane orifice.

### FIELD OF THE INVENTION

The present invention generally relates to a container with a dispenser.

### BACKGROUND OF THE INVENTION

Reusable baby bottles having a nipple-like dispenser are commercially available. Those plastic bottles are offer to sale empty, wherein the user is instructed to sterilize the bottle and its dispenser effectively before use, to admix a predetermined volume or weight of feeding formulas with predetermined volume of liquids such that foodstuffs and beverages are provided and finely to ensure all ingredients are well dissolved or mixed. In the state of the art, the parent must prepare enough (a) food and drinks for his infant (b) bottles and mouthpieces and (c) dispensing means, such as spoons, measuring cups etc before leaving home, and this is mainly because that foodstuffs and beverages ready to use by infants are not available. This food preparation is tedious, massy and sometimes dangerous, e.g., evolved food poison due to misfortune sterilization or preparation, accidental selection of toxic raw materials etc. Most of the users are babies and toddlers, so such a misfortune preparation might end with tragic results. A ready to use, easy to handle, cost effective food and beverage containing means are thus still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 schematically presents flexible and disposable containers according to one embodiment of the present invention, said container is integrally comprised of a flexible dispenser, and is shape as an infusion bag-like polymeric vessel and said dispenser is a rubber like nipple mouthpiece;

FIG. 2 schematically presents containers according to another embodiment of the present invention, having a bottle like shape adapted to store ready to use flowing materials and formulas;

FIG. 3 schematically presents carton made containers according to still another embodiment of the present invention; and,

FIG. 4 schematically presents carton containers according to another embodiment of the present invention, having a double jacket structure.

### SUMMARY OF THE INVENTION

It is the object of the present invention to provide a cost effective, preferably a disposable container integrally attached to at least one flexible dispenser, comprising a ready to use flowing edible content. This device is especially adapted for a mass production. It is another object of the present invention to provide a simple and novel method of providing ready to use edible foodstuff or beverage to users that cannot use commercially available bottles, having an aperture with a plane orifice.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a container for flowing materials comprising a container integrally attached to flexible dispenser, comprising a ready to use flowing edible content.

The term ‘container’ refers hereinafter to any vessel adapted to accommodate fluids and flowing materials. It is selected in a non-limited manner from bottle, can, box, flax, sealed bag, pouch or the like. It is hence acknowledged in this respect that the container may be at least partially flexible device, at least partially rigid device or any combination thereof.

The aforesaid container is preferably, yet not exclusively made of polymeric materials, such as polyethylene, polypropylene, e.g., high density PP, PE or PS, polyester, polyamide, nylon, polylactate, polyacetate, polyvinyl chloride, ethylene-vinyl acetate copolymer, silicon and/or Teflon™ containing polymers, rubber or the like; glass; paper-made, cellulose, fibers, cardboard, carton, or the like; aluminum, aluminum-magnesium allows, folded thin metallic sheets or the like; or any combination thereof. Said container may by either made homogenously or heterogeneously, and may be made of knitted yarns, fiber or the like, made of a continuous composition or any combination thereof.

It is in the scope of the present invention wherein the container comprising wall portion, providing a contained volume and a dispenser having at least one open bore in connection with said contained volume. The wall portion may be rigid, flexible or at least partially flexible. The measure of the contained volume may vary. For many purposes, said volume is of only few cube milliliters, such as for the case of dispensing medicaments, drugs, food additives, tea, tea extracts, probiotic formulas, vitamins solution, buffered fluids and the like; concentrated compositions, e.g., sweets and the like. For other purposes, and still in a non-limiting manner, said volume may rang from about 0.11 to about 1.51, such as for case for water, beverages, milk etc.

It is in the scope of the present invention wherein the aforesaid sterilized container is either empty or containing raw materials to which feeding formulas are admixed. Hence, said container is containing a diluent, e.g., water, milk or oily phase, to which the user is adding lyophilized, dried or sterilized feeding formula, extracts etc.

It is in the scope of the present invention wherein the container comprising double jacket wall, such that the main contained volume is accommodated inside a sleeve. Said sleeve may comprise either cooling or heating means, isolating means etc. Hence, cooling or heating means are selected in a non-limiting manner from a gas adapted to cool while expending, e.g., by escaping from the jacket outside or from small portion of the jacket to a bigger one and vice versa, compressed from a big portion to a small one. Additionally or alternatively, said sleeve may contain a solution, adapted for either exothermic or endothermic reaction with a catalyst or reactant, initially comprised in said sleeve volume coated by a means of isolating means.

It is further in the scope of the present invention wherein the container comprising more than one volume, e.g., a multi-compartment container, such that two or more fluids or flowing compositions may interact or mixed before or after use. Fluids or flowing compositions may selected in a non-limiting manner from liquids, water, aqueous solutions, water-immiscible solutions, emulsions, gas and gas mixtures, solublized or dispersed particles, fine particles, powders etc.

It is further in the scope of the present invention wherein the container comprising auxiliaries, selected inter alia from handles, hocks, levers; dispenser cup, reversibly or irreversibly attached the dispenser outer portion before use; indicative means, e.g., drawn lines or milliliters indicia adapted to indicate remaining volume in the container; valves or sealing membrane etc.

The term ‘dispenser’ refers hereinafter to any means adapted to provide a predetermined measure of fluids and/or flowing materials from the contained volume to the user, holding the orifice portion of the dispenser in its mouth. The dispensing means are selected in a non-limiting manner from nipples and nipples-like members; mouthpieces, including nipple-like members and/or pacifier-like members; straws, slender tubes and the like; snorkel-like mouthpieces etc. Preferably, the dispenser is made of a flexible, non-toxic material, such as silicone-containing polymers, rubber-like materials and the like.

The dispenser comprising a proximal portion, facing the user's mouth, and a distal portion, attached to the container, such that a fluid communication is provided. Said connection may provide for a free flow. Alternatively, a restricted flow or impedance is provided, such that only a predetermined flux or volume of fluid is allowed to flow. Moreover, sealing member, such as valve, membrane, capillaries or labyrinth array may be used.

The dispenser is effectively attached the container. Said attachment may be provided by any physical or chemical manner, such as clasping, gluing or melting the dispenser to the container wall. It is acknowledged in this respect that the dispenser may alternatively be reversibly or permanently removed from the container. It is further acknowledged that the dispenser is alternatively is connected to the container via an adaptor.

It is in the scope of the present invention wherein the container comprises ready to use flowing materials, selected inter alia from the group of medicaments, drugs, food additives, buffered or energizing solutions and the like. The flowing materials is further selected from a group inter alia comprising water, beverages, juices, syrups, milk, cocoa and other milk products, fruit or vegetable extracts, mashed fruits or vegetable mashed products or a puree thereof, gassed solutions, emulsions, water immiscible solutions, aqueous solutions or any combination thereof. Any flowing babies puree is potentially adapted to be contained in the container, such as soups and broths, e.g., vegetable, chicken, milk or meat soups. The flowing materials is further selected from a group inter alia comprising powders, fine particles, small solid or jelly like spheres etc. The flowing materials are frozen, cooled, remain at ambient temperature or heated up to a predetermined degree. Those compositions are preferably cleaned, sorted, deionized, sterilized or pasteurized before use, before admixed in the container or in any other stage.

It is well in the scope of the present invention wherein the container with a dispenser hereto defined is a disposable product. Preferably, it contains a ready to use formulas, foodstuffs, water, milk or beverages.

It is thus according to one embodiment wherein about 150 ml plastic bottle (container) comprising a microwave heated soup is offer to sale, wherein it integrally comprised a silicone nipple mouthpiece (dispenser), adapted for the use of babies. Said nipple is preferably adapted to be reversibly removed at the time of the heating.

It is according to yet another embodiment wherein about a 250 ml carton box comprising natural fruit nectar is offer to sale, wherein it integrally comprised a rubber orifice mouthpiece adapted for the use of toddlers and kids.

It is according to further another embodiment wherein a 500ml glass vessel comprising chilled cocoa is offer to sale, wherein it integrally comprised a flexible straw adapted for the use of youngsters.

It is still according to another embodiment wherein about a 1.5 plastic bottle comprising ready to use energizing solution is offer to sale, wherein it integrally comprised a snorkel-like mouthpiece adapted for sportsmen in their activity time.

It is according to another embodiment wherein a ready to use 11 flexible infusion-bag comprising isotonic water solution, wherein it integrally comprised a flexible straw adapted for the use by handicaps or other persons having restrictions in their movement.

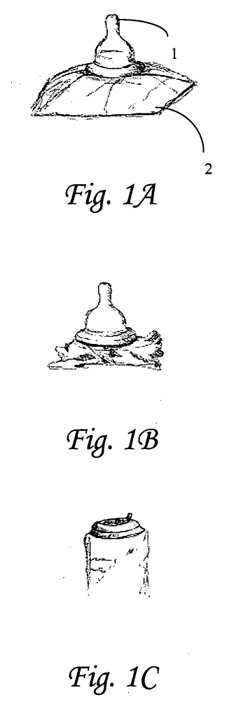

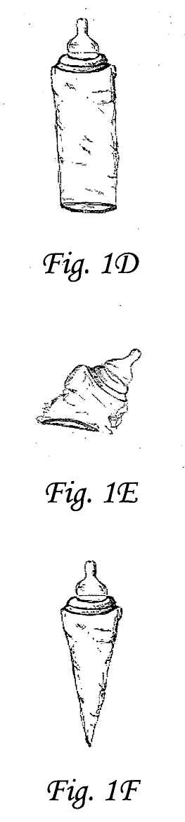

Reference is made now to FIG. 1, schematically presenting a flexible container (1A) with an integrated flexible dispenser (1B) (see device 10). The device may be in either folder or collapsible conformation (2) or in erected conformation (4) wherein the dispenser is either attached to the dispenser (4) or outside the container (3). After use, the container may be somewhat or entirely collapsed (5). The shape of the container may vary, e.g., bottle (4), bag (1A) or cone shape (6).

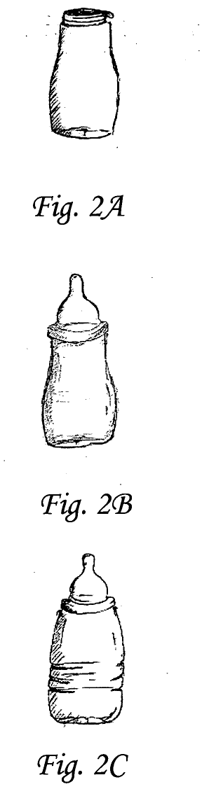

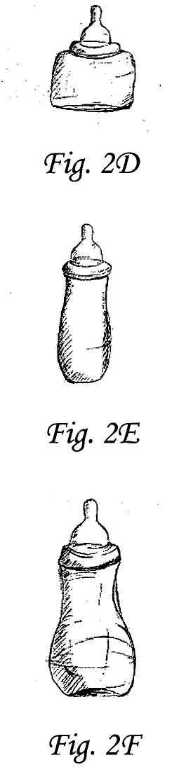

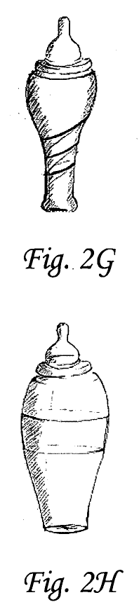

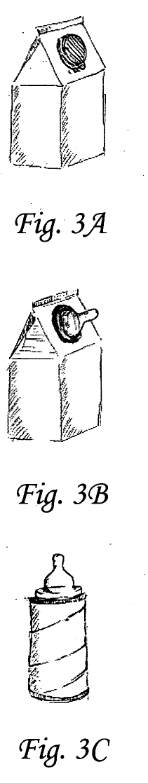

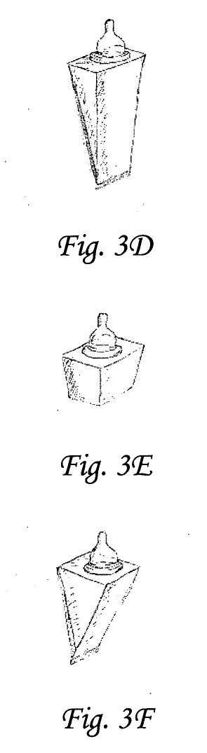

Reference is made now to FIG. 2, schematically presenting a disposable container ready to use (20) with an integrated flexible dispenser. Here again, the dispenser may be incorporated to the bottle like container (22), or separated (21) therefrom. The shape of the container may vary to any size and shape (23-28 for example). Said containers may be disposable or reusable, flexible or rigid.

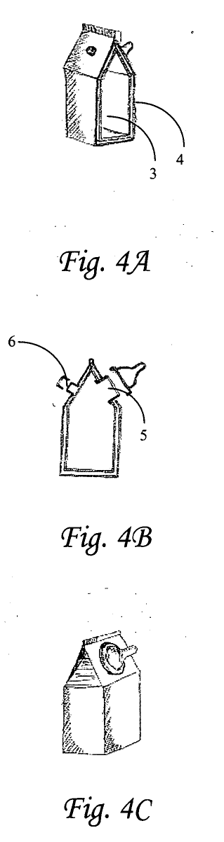

Reference is made now to FIG. 4, schematically presenting a carton-made container (40) with an integrated flexible dispenser. Said dispenser may be adapted to be removed (41) such that a sealing lead or membrane provides the content's sterilization on the shelf. An optional cup may be further appended. This disposable container may be of tubular shape (43) or other rectangular shapes (44-46).

Reference is made now to FIG. 5, schematically presenting the aforesaid carton-made container (50) comprising double jacket envelop, such that the ready to use flowing content is located in the inner volume (54) and a cooling (or heating) reactant is stored in the jacket volume (55). The content to use is dispensed via aperture (52), whereas the reactant composition is dispensed via a sealed bore (53). The external envelop of the container (51) and/or the inner envelop is potentially made of paper products or cardboard, metallic sheets, or polymeric materials. The reactant volume may stored at the enveloping sleeve or alternatively, in a respectively low volume inner sock such that the flowing edible content is stored at the outside compartment.

What is claimed is:

1. A container integrally attached to at least one flexible dispenser, comprising a ready to use flowing edible content.

2. A sterilized container according to claim 1, wherein said container is either empty or containing raw materials to which feeding formulas are admixed.

3. The container according to claim 1, wherein the container is selected among one of the group comprising bottle, can, box, flax, sealed bag, pouch or the like.

4. The container according to claim 1, wherein the container is at least partially flexible device, at least partially rigid device or any combination thereof.

5. The container according to claim 1, wherein the container and/or the dispenser is made of materials selected from the group of polymeric materials, polyethylene, polypropylene, e.g., high density PP, PE or PS, polyester, polyamide, nylon, polylactate, polyacetate, polyvinyl chloride, ethylene-vinyl acetate copolymer, silicon and/or Teflon^{TM} containing polymers, rubber or the like; paper-made, cellulose, fibers, cardboard, carton, or the like; aluminum, aluminum-magnesium allows, folded thin metallic sheets or the like; or any combination thereof.

6. The container according to claim 1, wherein the container and/or the dispenser is rigid, flexible or at least partially flexible.

7. The container according to claim 1, wherein the container volume is from about 10 ml to about 1.51.

8. The container according to claim 1, wherein the container comprising double jacket wall.

9. The container according to claim 8, wherein the enveloping sleeve comprising cooling, heating or isolating means.

10. A multi-compartment container according to claim 1.

11. The container according to claim 1, additionally comprising auxiliaries, selected from handles, hocks, levers; dispenser cup, indicative means, valves or sealing membrane or any combination thereof.

12. The container according to claim 1, wherein the flexible dispenser is adapted to provide a predetermined measure of fluids and/or flowing materials from the contained volume to the user, holding the orifice portion of the dispenser in its mouth.

13. The container according to claim 1, wherein the flexible dispenser is selected from a group comprising nipples or nipples-like members, mouthpieces, including nipple-like members and/or pacifier-like members, straws, slender tubes and the like, snorkel-like mouthpieces etc.

14. The container according to claim 1, wherein the ready to use flowing content is selected from the group of medicaments, drugs, food additives, buffered or energizing solutions and the like, water, beverages, juices, syrups, milk, cocoa and other milk products, fruit or vegetable extracts, mashed fruits or vegetable mashed products or a puree thereof, gassed solutions, emulsions, water immiscible solutions, aqueous solutions or any combination thereof, flowing babies puree, soups and broths, powders, fine particles, small solid or jelly like spheres or any combination thereof.

15. A method of providing ready to use edible foodstuff or beverage to users that cannot use bottles having an aperture with a plane orifice.
